(19) United States
(12) Patent Application Publication
(10) Pub. No.: US 2007/0276671 A1
(43) Pub. Date: Nov. 29, 2007

(54) System and method for announcement transmission

(76) Inventors: Ganesh Gudigara, Bangalore (IN); Dipak P. Koroth, Sunnyvale, CA (US)

Correspondence Address: FAY KAPLUN & MARCIN, LLP, 15O BROADWAY, SUITE 702, NEW YORK, NY, 10038, US

(21) Appl. No.: 11/439,142

(22) Filed: May 23, 2006

(51) Int. Cl. G10L 21/00

(52) U.S. Cl. 704/270.1

(57) ABSTRACT

Described is a system and method for announcement transmission. The system comprises a server and a network management arrangement coupled to the server. A wireless computing unit transmits an announcement request to the arrangement. The announcement request includes a first message in a non-audio format and output data identifying the server. The arrangement transmits the first message to the server as a function of the output data. The server converts the first message into a second message in an audio format and transmits the second message to an output device that plays the second message.

### FIELD OF THE INVENTION

The present invention generally relates to systems and methods for transmitting announcements wirelessly.

### BACKGROUND INFORMATION

In a conventional announcement system, transmission of an announcement is performed manually. A user must transmit the announcement in person from a predetermined transmission location. The transmission location is often a non-mobile announcement station (e.g., a service counter) equipped with an input device such as a microphone. If the user is not present at the announcement station and desires to transmit an announcement, the user must travel to the announcement station in order to transmit. Furthermore, the user cannot move from the announcement station prior to completion of the transmission. Accordingly, there exists a need for a system and a method of announcement transmission which allows the user to transmit announcements without being restricted to the predetermined transmission location.

### SUMMARY OF THE INVENTION

The present invention relates to a system and method for announcement transmission. The system comprises a server and a network management arrangement coupled to the server. A wireless computing unit transmits an announcement request to the arrangement. The announcement request includes a first message in a non-audio format and output data identifying the server. The arrangement transmits the first message to the server as a function of the output data. The server converts the first message into a second message in an audio format and transmits the second message to an output device that plays the second message.

### BRIEF DESCRIPTION OF THE DRAWINGS

FIG. 1 is an exemplary embodiment of a system according to the present invention;

FIG. 2 is an exemplary embodiment of a user interface according to the present invention;

FIG. 3 is an exemplary embodiment of messages according to the present invention;

FIG. 4 is an exemplary embodiment of a method according to the present invention;

FIG. 5 is an exemplary embodiment of another method according to the present invention; and

FIG. 6 is an exemplary embodiment of yet another method according to the present invention.

### DETAILED DESCRIPTION

The present invention may be further understood with reference to the following description and the appended drawings, wherein like elements are provided with the same reference numerals. The present invention relates to systems and methods for transmission of an announcement. More specifically, the present invention relates to systems and methods for wireless transmission of announcements from remote locations. An exemplary embodiment of the present invention is described in the context of a wireless local area network (“WLAN”), however those skilled in the art will understand that the present invention may be utilized in other wireless environments such as, for example, a wireless wide-area network (“WWAN”).

Announcement systems are used in many locations to provide audible information to individuals in each location. Examples of locations having announcement systems include retail stores, shopping malls, airports, hospitals, schools, sports stadiums, high rise buildings, etc. The announcements provided by these systems can provide any type of information to the individuals in the locations. Exemplary announcements include store closing times, sale information, lost child information, parking information, fire or other emergency information, flight information, etc.

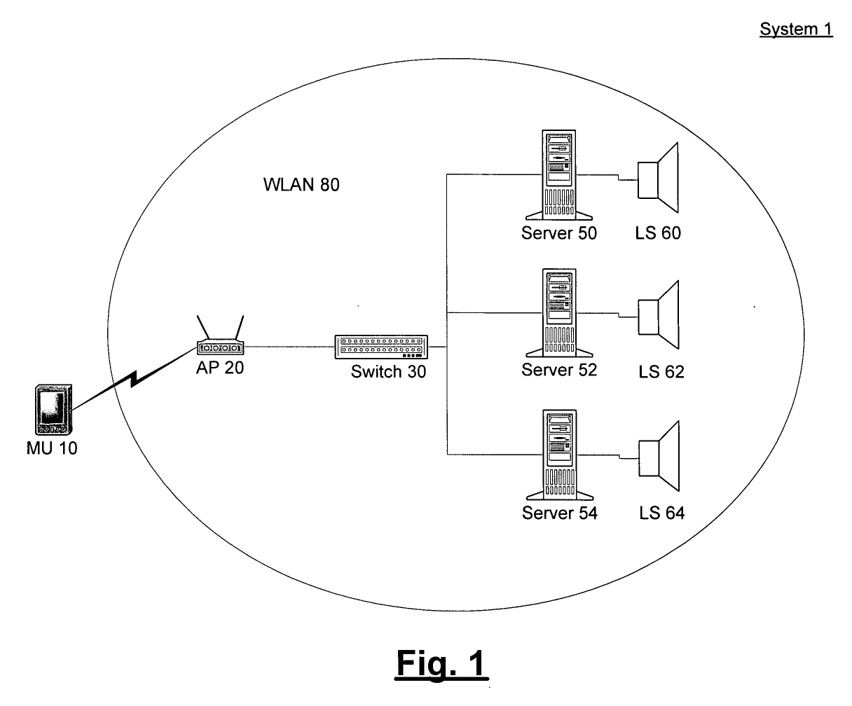

FIG. 1 shows an exemplary embodiment of a system 1 according to the present invention. The system 1 may include one or more access points (“APs”) 20 coupled to one or more servers 50,52,54 via one or more switches 30. The switch 30 may be a wireless switch in a wireless local-area network (“WLAN”) 80 providing access to the servers 50-54 for any devices coupled thereto. The switch 30 may also manage communications between the AP 20 and the servers 50-54. For example, the switch 30 may receive and process an announcement request received from a mobile unit (“MU”) 10. Those skilled in the art will understand that the number of devices in a particular network will vary based on various factors such as the number of users, the area to be covered, the purpose of the network, etc. Thus, the system 1 is only used for illustrative purposes.

The switch 30 may include an IP address that allows the MU 10 and the servers 50-54 to locate the switch 30 on the WLAN 80. When the MU 10 detects the AP 20, the IP address of the switch 30 may be transmitted to the MU 10, allowing communication between the MU 10 and the switch 30 to commence. The switch 30 may transmit the announcement request to one or more of the servers 50-54 for broadcasting, as will be described below. The switch 30 may also provide an interface (e.g., a command line interface) allowing a system administrator to configure the servers 50-54 (e.g., changing an IP address of a server, changing an audio setting, etc.). This interface for configuring the servers may also be provided via other network components such as other servers, network appliances, the servers themselves, etc.

Each of the servers 50-54 may include an announcement module for receiving and processing the announcement request prior to transmitting the announcement to an output device coupled thereto. That is, each server 50-54 may be coupled to one or more corresponding output devices (e.g., loudspeakers (LSs) 60,62,64) for broadcasting the announcement. The servers 50-54 may be configured by, for example, adding or removing a diaphone set (e.g., British male, British female, American male, American female, etc.) supported by each server 50-54. The servers 50-54 may each have a unique identifier (e.g., an IP address, a hardware address, etc.) that allows the switch 30 to access the server and, correspondingly, to transmit the announcement thereto. Thus, the announcement request may be transmitted to one or more servers using the unique identifier(s) associated with the server(s). The unique identifier may be transmitted to the switch 30 via periodic polling, upon startup of the server(s), whenever the unique identifier changes, etc.

The AP 20 may provide a connection for the MU 10 to the WLAN 80. The MU 10 may be any wireless computing unit (e.g., a mobile phone, a PDA, a laptop, an imager-/laser-based scanner, an RFID reader, a network interface card, etc.) capable of communicating wirelessly with the AP 20. The MU 10 may include or be coupled to an input arrangement (e.g., a keypad, a touchpad, etc.) for receiving user input (e.g., alphanumeric data). The MU 10 may also provide a user interface (e.g., a graphical user interface on a display) which allows a user to enter, view and transmit the announcement request to a particular server(s).

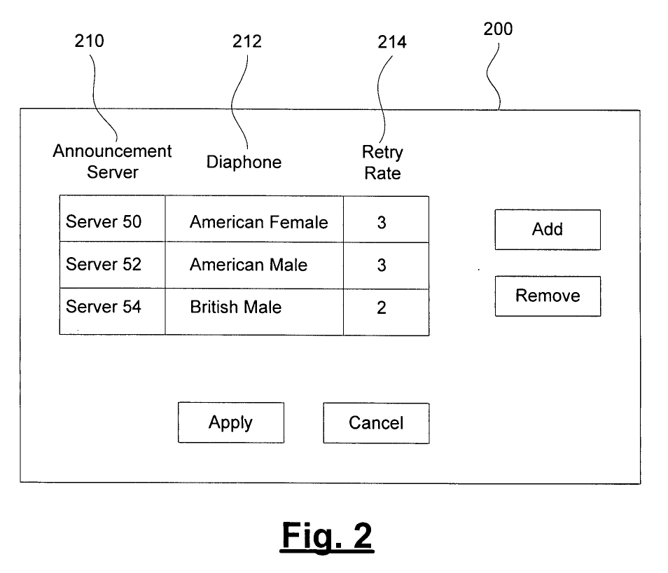

FIG. 2 shows an exemplary embodiment of a user interface 200. The user interface 200 may utilize any number of standard interface elements (e.g., text boxes, check boxes, drop down menus, etc.) and may include a list of announcement servers 210. The user interface 200 may also include a list of diaphones 212 supported by the servers 50-54 with corresponding retry rates 214. The retry rates 214 specify a time interval between attempts at transmitting the announcement request to the servers 50-54. For example, the switch 30 may await three seconds between attempts to transmit the announcement request to the server 50. In other embodiments, the interface 200 may also include a timeout rate that specifies a maximum number of transmission attempts and/or an elapsed time before the announcement request is aborted. The user interface 200 may further include one or more locations which correspond to each server 50-54. For example, the server 50 may be used to transmit the announcement in a retail store, while the server 52 is used for announcements in a parking lot of the retail store.

Those skilled in the art will understand that there may be many arrangements of announcement servers and loudspeakers. For example, in the system 1 each of the announcement servers 50-54 may have an individual announcement module corresponding to a loudspeaker (e.g., LSs 60-64) connected thereto. In a further example, there may be a single announcement server which has an announcement module that includes the functionality of each of the individual announcement modules. Accordingly, the loudspeakers may each be connected to the single announcement server, which may be able to send output to individual and/or groups of loudspeakers (e.g., the LS 60, the LSs 60-64, all loudspeakers in the parking lot, etc.). The user interface 200 provided on the MU 10 may be altered to display the system accordingly based on the arrangement of the servers and loudspeakers.

In one embodiment of the system 1, each of the components may be deployed in a single, closed environment such as a warehouse, a supermarket, an office, etc. However, those skilled in the art will understand that one or more of the LSs 60-64 may be located in an open environment, such as an outdoor stage or the parking lot. In yet further embodiments, the MU 10 and the AP 20 may be deployed as part of a network separate from, but in communication with, the WLAN 80. For example, the MU 10 may access the WLAN 80 via the Internet. Thus, the user may not be restricted to a particular geographic region in order to gain access to the WLAN 80.

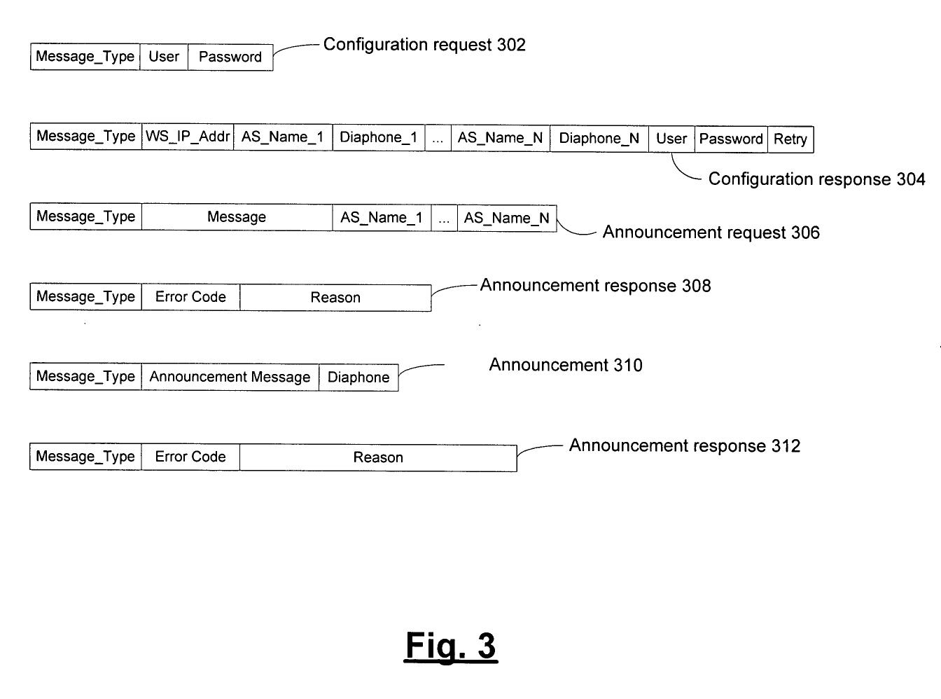

FIG. 3 shows an exemplary embodiment of messages according to the present invention. The exemplary embodiment utilizes request and response type messages, which are transmitted between the MU 10, the switch 30, and the servers 50-54. A message header may indicate the message type for each message. For example, a configuration request message 302 may include a message header (e.g., “MU_CONFIG_REQUEST”) followed by a username and password. The configuration request 302 may be transmitted by the MU 10 when requesting server configurations (e.g., a capability of each server 50-54 for supporting a particular diaphone). In response to the configuration request 302, the switch 30 may return a configuration response message 304 which includes a message header (e.g., “WS_CONFIG_RESPONSE”) followed by the IP address of the switch 30, one or more server names with corresponding supported diaphones, the username/password, and one or more retry rates. In some embodiments, the configuration response 304 may also include a location of each server.

An announcement request message 306 may include a message header (e.g., “MU_MESSAGE_REQUEST”) followed by a message and one or more servers to transmit the announcement request to. In response to the announcement request 306, the switch 30 may return an announcement response message 308 which includes a message header (e.g. “WS_MESSAGE_RESPONSE”) followed by an acknowledgment (e.g., an error code and/or reason for error).

After receiving the announcement request 306, the switch 30 may transmit an announcement message 310 to one or more selected servers. The announcement 310 may include a message header (e.g. “WS_MESSAGE_REQUEST”) followed by the message and one or more diaphones to play the announcement in. In response to the announcement 310, a selected server may transmit an announcement response message 312 to the switch 30 that may include a message header (e.g., “AS_MESSAGE_RESPONSE”) followed by an acknowledgment (e.g., an error code and/or reason for error).

Those skilled in the art will understand that the messages 302-312 may be formatted in any manner understandable by the MU 10, the switch 30, and the servers 50-54. For example, the message type may be included in a message footer rather than the message header. In further embodiments, the message type may not be included at all. Thus, the message formats are exemplary rather than limiting.

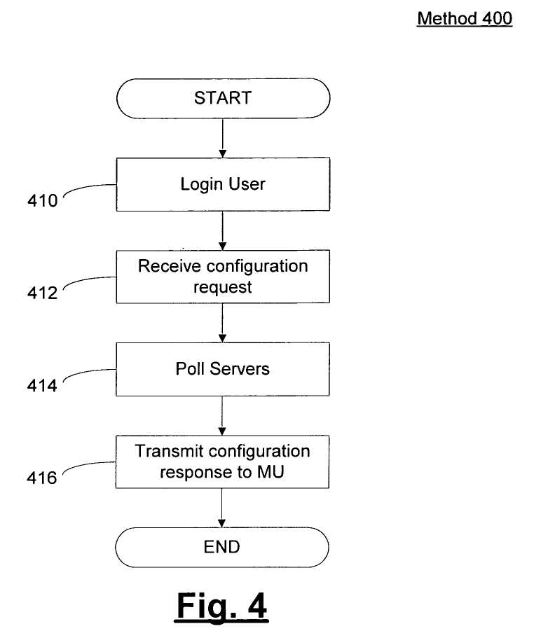

FIG. 4 shows an exemplary embodiment of a method 400 for receiving and processing a configuration request (e.g., the configuration request 302) from the MU 10 according to the present invention. The configuration request may allow the MU 10 to receive an updated list of available servers and may be initiated during startup of the MU 10, or manually at a request of the user. In step 410, the user is authenticated by, for example, logging into the switch 30 with the username and/or the password. The switch 30 may authenticate the user by verifying that the username and/or the password are valid. It should be noted that different users may have different security levels (e.g., a fire marshall may have access to all announcement servers, whereas a maintenance person may only have access to specific announcement servers). The authentication may verify this level of access and the subsequent steps of the method may be limited based on the user's level of access.

In step 412, the configuration request 302 is transmitted to the switch 30. In another embodiment, the configuration request 302 is transmitted when the user initiates transmission of the announcement. As described above, the switch 30 may access the servers 50-54 via the unique identifiers corresponding thereto. Thus, in step 414, the switch 30 polls the servers 50-54 (e.g., the servers to which the user's security level allows access) and receives the announcement capabilities (e.g., diaphones, announcement areas, etc.) supported by each of the servers 50-54. In other embodiments, the switch 30 may be configured to poll the servers 50-54 periodically in order to obtain the announcement capabilities. Thus, the switch 30 may only transmit a recent list of new diaphones obtained during a last scheduled polling rather than re-polling the servers 50-54.

In step 416, the switch 30 transmits the configuration response 304 to the MU 10. As previously described, the configuration response 304 may include a name of each server (e.g., server 50), an IP address of the switch 30, a corresponding diaphone (e.g., American female), and a location. This information may be displayed on the user interface 200 of the MU 10.

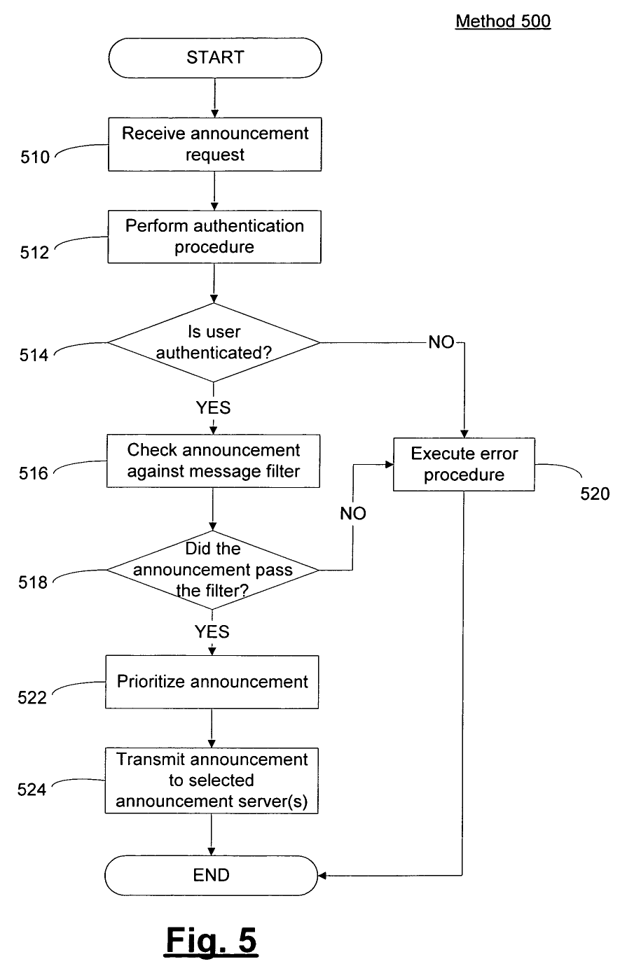

FIG. 5 shows an exemplary embodiment of a method 500 for receiving and processing an announcement request (e.g., the announcement request 306) according to the present invention. In the exemplary embodiment, the method 500 is implemented at the switch 30. However, the method 500 may be implemented at any device capable of managing the WLAN 80, such as the servers 50-54, a gateway server, etc. In step 510, the switch 30 receives the announcement request 306 from the MU 10. The user of the MU 10 may compose the announcement request using the user interface 200. As previously described, the announcement request 306 may include a text message comprising the announcement, and may also include a list of servers (e.g., server 50) to which the announcement will be transmitted. The announcement request 306 may further include data regarding how and/or where the announcement will be played. For example, if the server 50 supports more than one diaphone (e.g., American male and American female) and/or more than one LS (e.g., two LSs deployed at separate locations), the announcement request message 306 may specify which diaphone and/or location is desired.

In other exemplary embodiments, the message may be input using voice and encoded by the MU 10 for transmission to the switch 30. The MU 10 may perform a speech-to-text conversion, and, optionally, translate the speech/text to a different language. Those of skill in the art will understand that the speech-to-text conversion may be executed at the switch 30 or server receiving the message.

In step 512, the switch 30 performs the authentication procedure in order to determine whether the user is authorized to make the announcement. For example, the switch 30 may prompt the user to enter the username and/or the password and compare the username and/or the password against a user database. Accordingly, in step 514, the switch 30 determines if the user is authenticated. Those skilled in the art will understand that the user may not be prompted for the username and/or the password if the user is logged into the switch 30. For example, the user may not have logged out after transmitting the configuration request 302. Thus the user may have previously been authenticated.

In step 516, the user is authenticated (i.e., authorized to make the announcement) and the switch 30 checks the announcement against a message filter. For example, the message filter may be a database of keywords (e.g., inappropriate words such as curse words, racial slurs, etc.). If the announcement contains one or more of the keywords, the message filter may reject the announcement. Those skilled in the art will understand that the keywords may be selectively applied to the user. For example, a higher level user (e.g., a manager) may have a higher level of access, and therefore fewer keywords may be applied by the message filter to announcements from the higher level user. Thus, the message filter may be selected as a function of the user. Accordingly, in step 518, the switch 30 determines whether the announcement passes the message filter.

In step 520, an error procedure is performed. This may occur if the user was not authenticated successfully in step 512, and/or if the announcement failed to pass the message filter in step 518. The error procedure may include an error message (e.g., the announcement response 308) which is transmitted to the MU 10. For example, if the user was not authenticated, the error message may include a reason for the failed authentication (e.g., invalid username/password, insufficient access level, etc.). Similarly, if the announcement is rejected, the error message may include a reason for rejection. For example, the error message may include a body of the text message with the keywords marked (e.g., highlighted, underlined, etc.). Additionally, an alert may be transmitted to or stored for later retrieval by the system administrator. The alert may include information relevant to the error message (e.g., an error time, an error type, the username, location of the MU 10, etc.).

In step 522, the announcement has passed the message filter and the announcement may be prioritized for transmission to the selected server(s) (e.g., server 50). The announcement may be prioritized according to a conventional prioritization method, such as First In, First Out (“FIFO”) or Last In, First Out (“LIFO”). The announcement may also be prioritized according to a size/duration of the announcement (e.g., shorter messages may have higher priority), the time/location at which the announcement will be played (e.g., announcements scheduled to be played earlier may have higher priority), according to the access level of the user (e.g., higher access level users may have higher priority), identity of the MU 10, etc.

In step 524, the switch 30 transmits the announcement message 310 to the server 50 when a priority level of the announcement indicates that the announcement message 310 is ready to be transmitted. For example, the announcement message 310 may be transmitted immediately before the announcement is scheduled to be played, or when there are no higher priority requests. In one embodiment, the switch 30 may also transmit an acknowledgment (e.g., the announcement response 312) to the user indicating that the announcement has been successfully transmitted to the server 50.

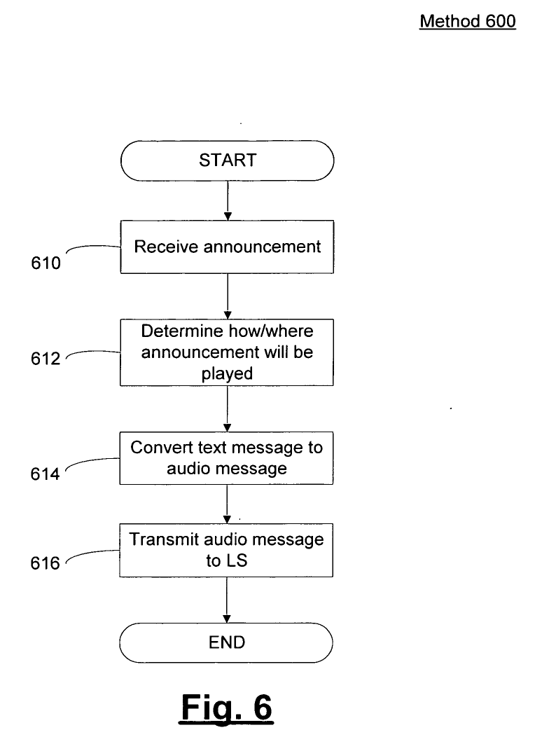

FIG. 6 shows an exemplary method 600 for receiving and further processing the announcement message 310 according to the present invention. In one embodiment, the method 600 may be implemented at the servers 50-54. However, in other embodiments, the method 600 may be implemented at any computing device receiving the announcement message 310 from the switch 30.

In step 610, the server 50 has received the announcement message 310 from the switch 30. The received announcement message may include the text message, a selected diaphone and/or a selected location. After receiving the announcement message 310, the server 50 may transmit an acknowledgment (e.g., the announcement response 312) to the switch 30 indicating that the announcement message 310 was received successfully.

In step 612, the server 50 determines how/where the announcement will be played based on the received announcement message. For example, the user may have selected the diaphone to be the American female, and the location to be that of the LS 60. Those skilled in the art will understand that the server 50 may be coupled to one or more LSs in one or more locations.

In step 614, the server 50 converts the text message to an audio message based on the selected diaphone. For example, the server 50 may utilize a voice synthesizer software module to search a diaphone database for a sound corresponding to each word of the text message. The server 50 may then combine the sounds to form the audio message.

In step 616, the server 50 transmits the audio message to the LS 60, which plays the audio message. The server 50 may send a further acknowledgment to the switch 30 after the audio message has been transmitted. The server 50 may then delete the received announcement message. In some embodiments, the server 50 may archive the received announcement in a database for later retrieval by the system administrator.

Those skilled in the art will understand that the present invention provides certain advantages over the conventional announcement system. For example, the present invention enables the user to transmit the announcement request 306 from any location in which the MU 10 is capable of accessing the WLAN 80. Furthermore, the user may also be capable of transmitting the announcement request 306 ahead of time. By specifying the time at which the announcement will be played, the user may schedule the announcement in advance, thus eliminating a need to be present when the announcement is played. Accordingly, the user may be able to establish regularly scheduled announcements. Thus, the present invention may eliminate both physical and temporal restrictions. In addition, because access to the system 1 is restricted to authorized users, and because the announcement is filtered before being played, the present invention provides a higher level of security. Yet another advantage may be the ability to record the announcement, allowing the system administrator to review the announcement after it is played for any number of reasons (e.g., security, statistics, system diagnostics, etc.).

According to an exemplary embodiment, the announcement request 306 may include a pre-recorded (i.e., canned) announcement. The pre-recorded announcement may correspond to any foreseeable and/or contingency condition for which it is desirable or more convenient to transmit the pre-recorded announcement rather than using the text message. For example, the pre-recorded message may be an indication of a special sale, an announcement of business hours, an emergency alert (e.g., a fire alarm), etc. Instead of inputting the text message, the user transmits an indication to play the pre-recorded announcement. This may require significantly fewer user actions (e.g., keystrokes, menu selections, etc.) than the text message, and is therefore more time efficient. In addition, the pre-recorded message may be easier to understand, since it can be recorded using complete sentences rather than as a concatenation of words and/or portions of words.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A system, comprising:
a server;
a network management arrangement coupled to the server; and
a wireless computing unit transmitting an announcement request to the arrangement, the announcement request including a first message in a non-audio format and output data identifying the server,
wherein, the arrangement transmits the first message to the server as a function of the output data, and
wherein, the server converts the first message into a second message in an audio format and transmits the second message to an output device that plays the second message.

2. The system of claim 1, wherein the arrangement is a wireless switch.

3. The system of claim 1, wherein the non-audio format is a text format.

4. The system of claim 1, wherein the arrangement performs a user authentication procedure prior to transmitting the first message.

5. The system of claim 1, wherein the arrangement passes the first message through a message filter prior to transmitting the first message.

6. The system of claim 5, wherein the message filter includes a list of keywords that are not allowable for transmission.

7. The system of claim 1, wherein the converting of the first message is performed as a function of an audio configuration of the server.

8. The system of claim 7, wherein the audio configuration includes a diaphone set.

9. The system of claim 7, wherein the audio configuration is specified by the announcement request.

10. The system of claim 1, wherein the server transmits the second message to a plurality of output devices.

11. The system of claim 1, wherein the announcement request specifies that the second message is to be played on the output device.

12. The system of claim 1, wherein the playing of the second message is scheduled by the announcement request.

13. The system of claim 1, wherein the second message is a pre-recorded message.

14. A method, comprising:
receiving in a network management arrangement an announcement request from a user of a wireless computing unit, the announcement request including a message in a non-audio format;
determining whether the user has sufficient access privileges to transmit the message to a server specified by the announcement request;
applying a message filter to the message; and
transmitting the message to the server if the user has sufficient privileges and the message passes the filter.

15. The method of claim 14, wherein the non-audio format is a text format.

16. The method of claim 14, wherein the management arrangement is a wireless switch.

17. The method of claim 14, wherein the message filter includes a list of keywords that are not allowable for transmission.

18. The method of claim 14, wherein the announcement request specifies an audio configuration of the server.

19. The method of claim 18, wherein the audio configuration is a diaphone set.

20. The method of claim 14, wherein the announcement request schedules playing of the message.

21. A method, comprising:
receiving in a server an announcement request including a message in a non-audio format;
converting the message into an audio format based on an audio configuration of the server; and
playing the message over an output device coupled to the server.

22. The method of claim 21, wherein the non-audio format is a text format.

23. The method of claim 21, wherein the announcement request specifies the audio configuration.

24. The method of claim 21, wherein the audio configuration is a diaphone set.

25. The method of claim 21, wherein the server is coupled to a plurality of output devices.

26. A system, comprising:
a first computing means;
a management means coupled to the first computing means; and
a mobile communication means for transmitting an announcement request to the arrangement, the announcement request including a first message in a non-audio format and output data identifying the first computing means,
wherein, the mobile communication means includes a transmission means for transmitting the first message to the first computing means as a function of the output data,
wherein, the first computing means includes a conversion means for converting the first message into a second message in an audio format and transmitting the second message to an output means for playing the second message.
